(19) United States
(12) Patent Application Publication
(10) Pub. No.: US 2004/0233158 A1
(43) Pub. Date: Nov. 25, 2004

(54) Systems and methods for identifying user input

(76) Inventors: Donald J. Stavely, Windsor, CO (US); Wilfred F. Brake, Fort Collins, CO (US); Dan L. Dalton, Greeley, CO (US); James C. Dow, Ft. Collins, CO (US); Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/442,838

(22) Filed: May 21, 2003

(51) Int. Cl. G09G 5/00

(52) U.S. Cl. 345/156

(57) ABSTRACT

Disclosed are systems and methods for identifying user input. In one embodiment, a system and method pertain to detecting application of a force to a user interface using input sensors that are laterally spaced from the point at which the force is applied, and calculating the location at which the force is applied using information collected by the input sensors.

### BACKGROUND

Many devices comprise user interfaces with which users can enter inputs (e.g., selections and/or data) into the device. Such interfaces typically comprise one or more of mechanical buttons and a touch-sensitive display.

With regard to mechanical buttons, physical switches are required for each button to register its selection by the user. Such switches are susceptible to errors, such as failure to register user selection. For example, dust and other debris can collect on the switches and interfere with the proper operation of the switches, and therefore the buttons that they serve. Moreover, liquids spilled on the switches may cause the switches to short-circuit, thereby requiring replacement of the user interface that comprises the switches, or even the entire device.

Although touch-sensitive displays are not as susceptible to the entry of dust, debris, or other contaminants in that such displays are normally scaled from the outside environment in which they are used, touch-sensitive displays are relatively fragile. In particular, the plastic layers that form typical touch-sensitive displays (e.g., resistive displays) may be easily scratched, gouged, or torn. In addition, the components (conductive films, protective layers, etc.) used to make a display touch-sensitive often reduce the brightness of the display. Therefore, the displayed information may be difficult to see, or the dimming effect of the touch-sensitive components must be overcome, thereby wasting power.

### SUMMARY

Disclosed are systems and methods for identifying user input. In one embodiment, a system and method pertain to detecting application of a force to a user interface using input sensors that are laterally spaced from the point at which the force is applied, and calculating the location at which the force is applied using information collected by the input sensors.

### BRIEF DESCRIPTION OF THE DRAWINGS

The disclosed systems and methods can be better understood with reference to the following drawings. The components in the drawings are not necessarily to scale.

FIG. 1 illustrates an exemplary embodiment of a first device that is configured to identify user input.

FIG. 2 illustrates an exemplary embodiment of a second device that is configured to identify user input.

FIG. 3 is a block diagram of an exemplary embodiment of the architecture for either or both of the devices shown in FIGS. 1 and 2.

FIG. 4 is a flow diagram that illustrates an exemplary embodiment of a method for identifying user input.

### DETAILED DESCRIPTION

An exemplary user interface comprises input sensors that are provided within the device housing, for instance inside a device control panel or display, that detect the application of force by a user. The information collected by the sensors is then analyzed to determine the location at which the force was applied, and thereby identify the user input.

Various embodiments of systems and methods that incorporate the disclosed user interfaces are described herein. Although particular embodiments are disclosed, these embodiments are provided for purposes of example only to facilitate description of the disclosed systems and methods. Accordingly, other embodiments are possible.

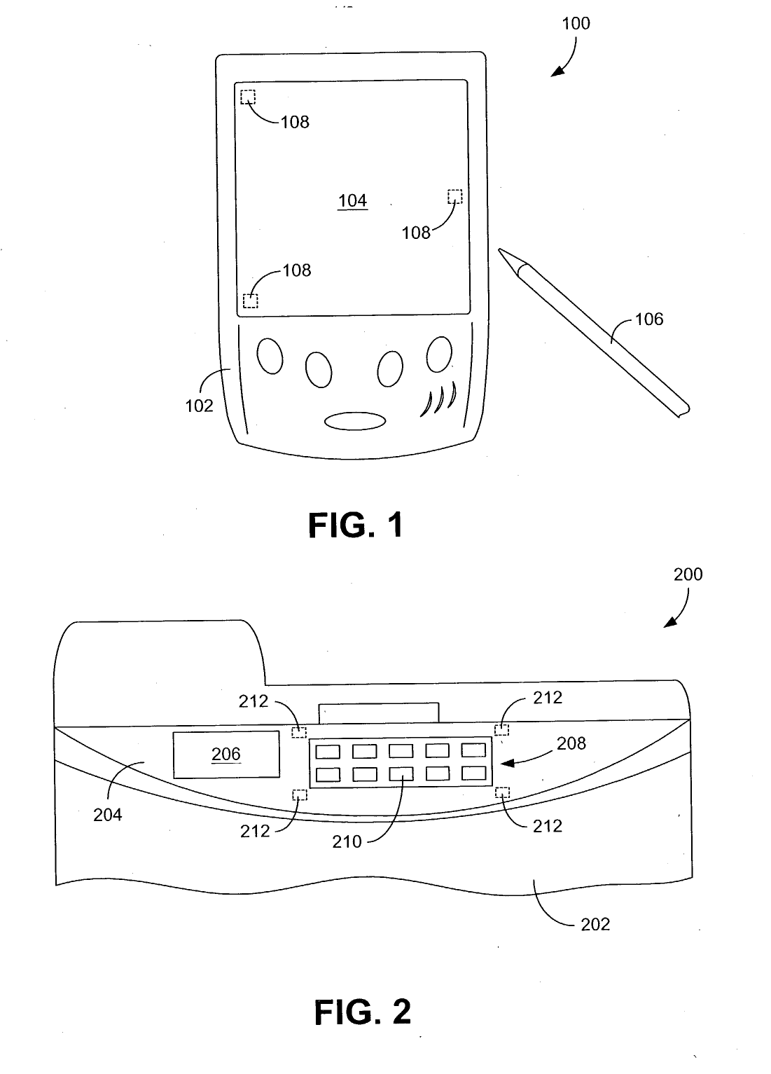

Referring now in more detail to the figures in which like numerals identify corresponding parts, FIG. 1 illustrates an embodiment of a first device 100 that is configured to identify user input. In this embodiment, the device 100 is a personal digital assistant (PDA). As indicated in FIG. 1, the device 100 comprises a housing 102 that supports a touch-sensitive display 104. Although capable of other configurations, the display 104 typically comprises a liquid crystal display (LCD) that receives user input entered using an appropriate input implement such as a stylus 106.

Provided within the housing 102, for instance underneath or within the display 104, are input sensors 108. In the embodiment of FIG. 1, three such input sensors 108 are used, one being provided at each of the top and bottom left corners of the display 104, and one sensor being provided near the center of the right edge of the display. Although three sensors 108 are shown and particular locations for these sensors are depicted, alternative arrangements may be used. For example, greater than three sensors can be used and/or can be positioned beyond the edges of the display 104.

Due to the provision of the input sensors 108 (example configurations for which are described below) the display 104 need not comprise layers of flexible plastic as in conventional touch-sensitive displays. Accordingly, a harder material, such as glass or scratch-resistant plastic, may be used in the construction of the display 104. In such a case, the display 104 is more robust and requires less energy to provide bright images to the user.

FIG. 2 illustrates an embodiment of a second device 200 that is configured to identify user input. In this case, the device 200 is an imaging device, such as a photocopier, a scanner, a facsimile machine, a printer, or other electronic device configured to identify user input. The device 200 comprises a housing 202 that includes a control panel 204 that, in turn, comprises a display 206 and a “keypad” 208. As with the display 104 of the device 100 shown in FIG. 1, the display 206 typically comprises an LCD. The keypad 208 includes a plurality of mock buttons 210. Although the term “buttons” is used, the mock buttons 210 do not comprise actual, mechanical buttons. Instead, the mock buttons 210 merely represent such mechanical buttons. Accordingly, the mock buttons 210 comprise one or more of indicia that identifies a given function (e.g., “print,” “copy,” etc.) that can be selected when the mock button is pressed, as well as an indication as to the boundaries of the mock button. In some cases, the boundary indication may comprise indentations and/or raised portions (e.g., raised edges) that communicate the bounds of the mock buttons 210.

Instead of a dedicated switch being provided for each of the mock buttons 210, a relatively small number of input sensors 212 are provided that are used to detect user selections. These input sensors 212 are mounted inside the control panel 204 adjacent the keypad 208. More particularly, in the embodiment of FIG. 2, four input sensors 212 are provided around the periphery of the keypad 208, one near each corner of the keypad. Although four input sensors 212 are shown in FIG. 2, an alternative number of sensors could be used. Moreover, the input sensors 212 can be provided at other locations within the device housing 202, if desired.

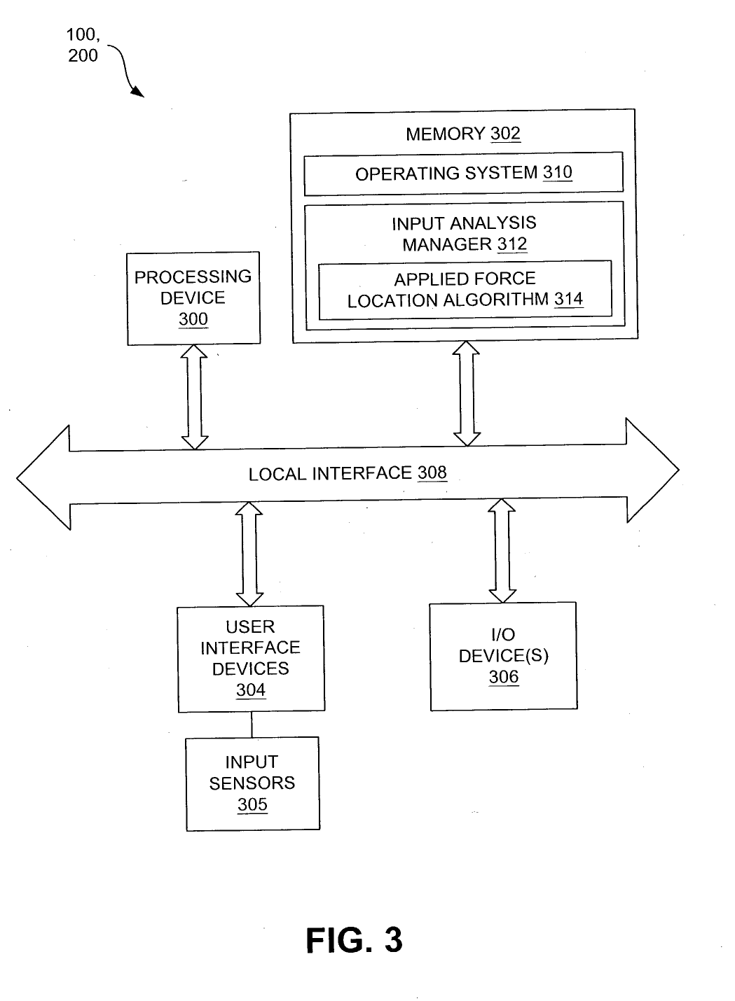

FIG. 3 is a block diagram illustrating an example architecture for one or both of the devices 100, 200 shown in FIGS. 1 and 2. As indicated in FIG. 3, the device 100, 200 generally comprises a processing device 300, memory 302, a user interface 304 (either the display 104 or the keypad 208), and input/output (I/O) devices 306, each of which is connected to a local interface 308.

The processing device 300 comprises any one of a general-purpose processor, a microprocessor, one or more application-specific integrated circuits (ASICs), a plurality of suitably configured digital logic gates, or other electrical configuration comprised of discrete elements that coordinate the overall operation of the device 100, 200. The memory 302 includes any one or a combination of volatile memory elements (e.g., random access memory (RAM)) and/or nonvolatile memory elements (e.g., Flash memory, hard disk, etc.).

The configuration of the user interface 304 depends upon the nature of the device in which it is used. In any case, however, the user interface 304 includes or is associated with a limited number of (e.g., three or four) input sensors 305 that are used to locate a point at which force was applied to the user interface. These input sensors 305 are laterally spaced from the point at which the force is applied. For example, the sensors 305 can be placed at or around the perimeter of the user interface 304 and therefore comprise perimeter input sensors. As used herein the term “input sensor” designates any sensor that is configured to detect a force applied to the user interface. Therefore, the input sensors 305 can comprise a force sensor that is configured to measure force that is transmitted through the user interface 308, such as a strain gauge or force transducer. In an alternative arrangement, the input sensors 305 may be configured to measure deflection of the user interface 304. In such a case, the input sensors 305 may comprise an optical sensor (e.g., optical transducer) that measures deflection of a discrete portion of a device display or control panel.

In yet another arrangement, the input sensors 305 may be configured to detect the arrival of and/or measure the intensity of vibrations (e.g., sound waves) that propagate through the user interface 304. For instance, the input sensors 305 may comprise an accelerometer that, for example, includes a beam that deflects when vibrations are transmitted to it. To cite another example, the input sensors 305 may comprise a microphone. Mere detection of the vibrations can be used to identify the various times at which the vibrations arrived at the sensors so that the location of the applied force can be calculated. Similarly, the measured intensity of the vibrations may be used for the same purpose. As is described below, sensors that detect the arrival of vibrations (e.g., sound waves) are particularly well-suited to detect application of an impulsive force, such as a “tap” that is applied to the user interface (e.g., display or control panel) using a hard implement such as a stylus or pen.

The I/O devices 306 comprise those devices that enable communication between the device 100, 200 and another device. Accordingly, these devices 306 can comprise, for example, a universal serial bus (USB) connector, a wireless (e.g., infrared (IR) or radio frequency (RF)) transceiver, or a network card.

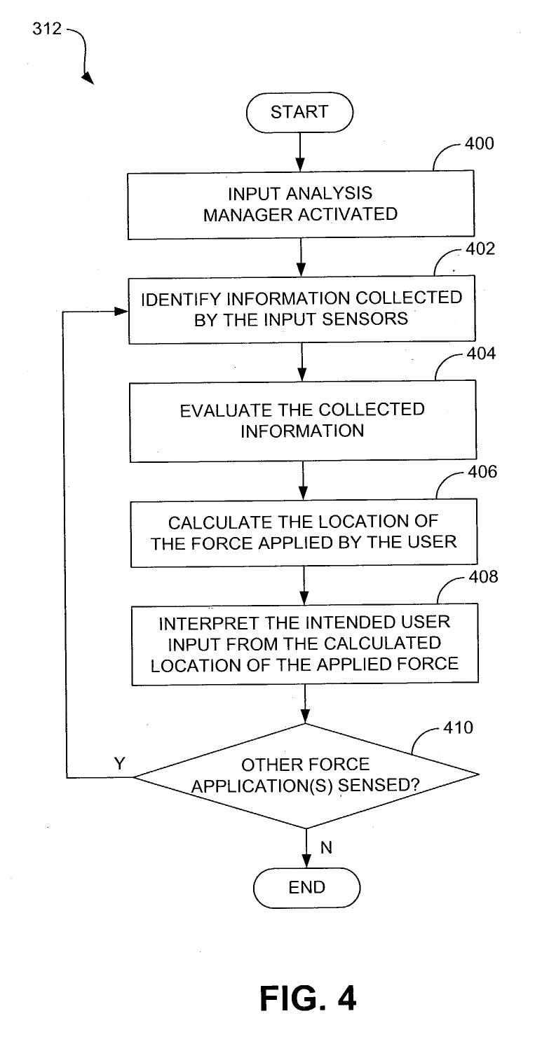

The memory 302 comprises various programs (in software and/or firmware) including, among others, an operating system (O/S) 310 and an input analysis manager 312. The O/S 310 controls the execution of other programs and provides scheduling, input-output control, file and data management, memory management, and communication control and related services. The input analysis manager 312, for example using an applied force location algorithm 314, evaluates the information collected by the input sensors 305 (e.g., sensors 106 or 212) of the user interface 304 and calculates the exact location at which the user applied force to the device (e.g., display 104 or control panel 208). Examples of operation of the input analysis manager 312 are described in relation to FIG. 4.

Various programs have been described above. These programs can be stored on any computer-readable medium for use by or in connection with any computer-related system or method. In the context of this document, the computer-readable medium can be, for example, an electronic, magnetic, optical, electromagnetic, infrared, or semiconductor system, apparatus, device, or propagation medium. More specific examples of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). The computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example devices having been described above, device operation in identifying user input will now be discussed with reference to the flow diagram of FIG. 4. Any process steps or blocks in this flow diagram may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 illustrates an embodiment of a method for identifying user input into a device. Beginning with block 400, the input analysis manager 312 is activated. This activation occurs in response to an application of force to the user interface being sensed by at least one of the input sensors, presumably indicating that a user is attempting to enter an input (e.g., a selection or data). For example, the user can have pressed or tapped an onscreen “button” or written something using a stylus. In another example, the user can have pressed down on a mock button provided in a device control panel.

Once the input analysis manager 312 is activated, it identifies the information collected by the input sensors, as indicated in block 402. The nature of this information depends upon the nature of the input sensors that collected it. In cases in which actual force sensors are used, the information may comprise voltages that can be correlated to measured forces. In cases in which a deflection sensor is used, the information comprises a measurement of deflection of the user interface at discrete portions of the interface. In cases in which the input sensors are configured to detect and/or measure vibrations (e.g., sound waves) that propagate through the user interface, the information comprises identification of the arrival of the vibrations or indication of the intensity of the vibrations.

Irrespective of the nature of the collected information, the information is then evaluated by the input analysis manager 312, as indicated in block 404. During this evaluation, the information collected by each individual input sensor is analyzed, knowing the distance between each input sensor, to calculate the strength and location at which the force was applied by the user. From these distances, the exact location at which the force was applied can be calculated, as indicated in block 406. If the information comprises the forces measured by each sensor, the differential forces are used to calculate, using the applied force location algorithm 314, the distances. Similarly, differential deflection information or vibration intensity information can be used to calculate the distances between each input sensor and the force application point using the location algorithm 314.

If the information collected by the sensors comprises mere indication of arrival of vibrations (e.g., sound waves), evaluation of the information comprises identification of the time at which the vibrations arrived at each of the input sensors and correlating these times to distance from the force application point.

Once the location of the applied force has been determined, this location is used to interpret the intended user input, as indicated in block 408. For example, if it is determined that the force was applied within the boundaries of an onscreen button or mock button of a control panel, selection of the function associated with that button is inferred. Similarly, if it is determined that the force was applied within a text entry box, the force application is interpreted as comprising a data entry (e.g., entry of an alphanumeric character). Such interpretation is facilitated by mapping, i.e., by using a “map” of the user interface that correlates locations with associated functions.

At this point, it is determined whether other force applications are sensed by the input sensors, as indicated in decision block 410. If not, flow for the input analysis manager 312 is terminated. If, on the other hand, other force applications are sensed, flow returns to block 402 and the above-described process continues such that all user inputs are identified.

In the foregoing discussions, the input sensors are described as being used to detect the application of force within particular user interfaces, such as a device display or control panel. Using the systems and methods described herein, however, user input other than that registered using such an interface can be identified. For instance, squeezing of the device housing at a given location may be detected and therefore used to input a given command (e.g., to scroll a device display). Therefore, the term “user interface” broadly applies to any location on the device housing at which an applied force may be detected and interpreted.

What is claimed is:

1. A method for identifying a user input, comprising:
detecting application of a force to a user interface using input sensors that are laterally spaced from a point at which the force is applied; and
calculating the location at which the force is applied using information collected by the input sensors.

2. The method of claim 1, wherein detecting application of a force comprises detecting application of a force using input sensors positioned at a perimeter of the user interface.

3. The method of claim 1, wherein calculating the location at which the force is applied comprises comparing the information collected by each of the input sensors.

4. The method of claim 1, wherein calculating the location at which the force is applied comprises calculating the location from forces measured by the input sensors.

5. The method of claim 1, wherein calculating the location at which the force is applied comprises calculating the location from deflections measured by the input sensors.

6. The method of claim 1, wherein calculating the location at which the force is applied comprises calculating the location from vibrations measured by the input sensors.

7. The method of claim 1, wherein calculating the location at which the force is applied comprises calculating the location from the times at which vibrations are detected by the input sensors.

8. The method of claim 1, further comprising interpreting an intended user input from the calculated location.

9. The method of claim 8, wherein interpreting an intended user input comprises correlating the calculated location using a user interface map.

10. A system for identifying a user input, comprising:
a user interface to which a force may be applied to register a user input;
input sensors that are laterally spaced from areas of the user interface to which the force may be applied; and
an input analysis manager that is configured to calculate the location at which a force is applied to the user interface using information collected by the input sensors.

11. The system of claim 10, wherein the user interface comprises a display.

12. The system of claim 11, wherein the input sensors are positioned at a perimeter of the display.

13. The system of claim 10, wherein the user interface comprises a control panel including at least one mock button.

14. The system of claim 13, wherein the input sensors are positioned at a perimeter of the control panel.

15. The system of claim 10, wherein the input sensors comprise a force sensor that measures force transmitted through the user interface.

16. The system of claim 10, wherein the input sensors comprise a displacement sensor that measures displacement of a discrete portion of the user interface.

17. The system of claim 10, wherein the input sensors comprise a vibration sensor that measures vibrations that propagate through the user interface.

18. The system of claim 10, wherein the input sensors comprise a vibration sensor that detects arrival of vibrations that propagate through the user interface and wherein the input analysis manager is configured to identify the time at which the vibrations arrived at each vibration sensor.

19. The system of claim 10, wherein the input analysis manager is configured to calculate the distances between the input sensors and the location at which the force was applied by comparing the information collected by the sensors.

20. The system of claim 10, wherein the input analysis manager is configured to interpret an intended user input from the calculated location at which the force was applied.

21. A system for identifying a user input, comprising:
means for detecting a force applied to a user interface, the means for detecting being laterally from the location at which the force was applied; and
means for calculating the location of the applied force.

22. The system of claim 21, wherein the means for detecting comprise no greater than four input sensors.

23. The system of claim 21, wherein the input sensors are positioned around a perimeter of the user interface.

24. The system of claim 21, wherein the means for calculating comprise means for calculating the distances between input sensors and the location at which the force was applied.

25. A user interface, comprising:
a display having an outer perimeter; and
input sensors provided only around the outer perimeter of the display, the input sensors being configured to detect application of force to the display.

26. The user interface of claim 25, wherein the interface only comprises three input sensors.

27. A user interface, comprising:
a control panel including a plurality of mock buttons; and
input sensors laterally spaced from the mock buttons that are configured to detect application of force to the mock buttons.

28. The user interface of claim 27, wherein the mock buttons comprise indicia that identify an associated function and an indication as to the boundaries of the mock buttons, the interface being absent of dedicated switches for the mock buttons.
